(19) United States
(12) Patent Application Publication
(10) Pub. No.: US 2003/0011157 A1
(43) Pub. Date: Jan. 16, 2003

(54) Suspension system with a slider enabling camber

(76) Inventors: Francis Aubarede, Pontgibaud (FR); Michel Deal, St-Remy-en-Rollat (FR)

Correspondence Address: BAKER & BOTTS, 30 ROCKEFELLER PLAZA, NEW YORK, NY, 10112

(21) Appl. No.: 10/192,789

(22) Filed: Jul. 10, 2002

(30) Foreign Application Priority Data
Jul. 10, 2001 (FR) 01/09248
Dec. 12, 2001 (FR) 01/16178

(51) Int. Cl. B60G 7/02; B62D 17/00

(52) U.S. Cl. 280/86.751

(57) ABSTRACT

The invention relates to a support system designed to connect a wheel (2) to suspension elements comprising an intermediate support (4), wherein the support system comprises (a) a wheel support (3) designed to carry the wheel (2), and at least one curved slider (10) that connects the wheel support (3) to the intermediate support (4), and wherein the curved slider (10) confers upon said wheel (2) a degree of camber freedom relative to the suspension elements.

### BACKGROUND OF THE INVENTION

The present invention concerns vehicle ground contact systems, in particular suspension systems and more particularly the guiding of the wheels. Suspension systems have two main functions, which must co-exist at all times during operation. The first of those functions is to provide suspension for the vehicle, so as to allow each wheel to move up and down essentially vertically as a function of the load on the said wheel. The second function of such systems is to guide the wheel, in other words to control the angular position of the wheel plane.

The “wheel plane” is the plane related to the wheel that is perpendicular to the wheel's axis and that passes through the center of the ground contact patch. The angular position of the wheel plane relative to the body of the vehicle is defined by two angles, the camber angle and the steering angle. The camber angle of a wheel is the angle which, in a transverse plane perpendicular to the ground, separates the wheel plane from the median plane of the vehicle. This angle is positive when the top of the wheel is tilted away from the median plane towards the outside of the vehicle, and this is now referred to as “camber” or “positive camber.” Conversely, when the said angle is negative this is called “reverse” or “negative camber.” The steering angle of a wheel is the angle which, in a horizontal plane parallel to the ground, separates the wheel plane from the median plane of the vehicle.

In most vehicles the camber angle (“camber” or “camber angle” will be used interchangeably in what follows) is fixed for a particular position of the suspension and steering, i.e. it can theoretically not vary independently of the deflection of the suspension or of the steering. However, it undergoes variations induced by the deformation of the elements constituting the suspension system brought about by the forces exerted on the wheel by the ground. These variations can be considerable. For example, in a modem passenger car the camber can vary several degrees under the transverse forces acting on the tire when going round a bend. This “elastic” camber variation increases the camber (the camber tends towards positive values) for the wheel on the outside of the bend. Conversely, the camber decreases (tending towards negative values) for the wheel on the inside of the bend. For a long time these predictable variations have been allowed for in design or tuning compromises of the suspension systems of modem vehicles, to limit their undesirable effects on the operation of the ground contact system.

In effect, camber greatly influences the vehicle handling and the performance of the suspension system. In particular, the performance of a tire varies a great deal depending on the configuration of its contact patch, and that configuration depends largely on the camber. It is these variations which mainly motivate the choice of the static camber angle. Thus, for example, a large static negative camber is generally used in a racing vehicle to compensate variations caused by deformations of the tire and suspension elements under transverse forces (even though these are much more rigid than in passenger vehicles), and by rolling of the body. This configuration is both useful and acceptable in racing because the criteria of grip around bends are then predominant. In contrast, in a passenger vehicle reduced tire wear and stability in a straight line carry more weight in the compromise sought. For a passenger car, therefore, the initial static camber chosen is zero or very slightly negative. Lower lateral slip thrust has thus to be accepted when the effects of deformations of the tire and the suspension elements under the lateral forces upon the position of the wheel plane are added to the effects of vehicle roll (mainly around bends). In effect, body roll (the body generally inclines towards the outside of the bend under the action of centrifugal force) also tends to tilt the wheels relative to the plane of the ground.

To optimise the camber, especially during transverse accelerations, suspension systems have been designed whose camber varies as a function of the vertical deflection of the wheel. In this way the body roll of the vehicle can induce a useful variation of the camber which partly or fully compensates the inclination of the vehicle's body and the deformations described above. This in particular is the case in the so-termed “multi-arm” or “multi-link” systems. Such systems require specific vehicle design and structure which, for reasons related to space occupied and cost, cannot be implemented on most current vehicles. These systems only react in response (load transfer resulting in an asymmetrical deflection of the suspension and hence rolling) to a transverse acceleration and not to the forces that give rise to it, and this delays the effect of the correction. Moreover, to enable a sufficient camber variation, the kinematics of such systems entail displacements of the contact patch relative to the vehicle, known as “track variations” or “half-track variations”, and these variations can also be disturbing. The camber correction amplitude made possible by such systems is relatively limited if one wishes to respect the compromise required for proper operation under other load conditions, such as rolling on a bumpy road, unilateral deflection, or on the contrary, simultaneous deflection.

From the kinematic point of view, in terms of degrees of freedom, suspension systems generally have only one degree of freedom (of the wheel or wheel support relative to the vehicle). This degree of freedom allows vertical suspension movements which, as just described, can be combined with limited camber variations.

However, systems are known in which the camber control is active, in other words the geometry modifications are brought about by movements of jacks as described, for example, in the documents U.S. Pat. No. 4,515,390 and DE 19 717 418. These systems allow at least one additional degree of freedom controlled by actuators. Such systems are very particular. They cannot be used on most ordinary vehicles, particularly because of the space they occupy, their complexity, and the high power required for the actuators.

One purpose of the present invention is to provide a suspension system of simple design that enables the camber to be controlled, without any or with only low energy input, essentially independently of the vertical oscillations of the suspension, and more generally, the movements of the vehicle body, and that enables track variations to be minimized.

This objective is achieved by a support system designed to connect a wheel to suspension elements of a vehicle, the support system comprising a wheel support and camber means that confer upon the wheel a degree of freedom of camber relative to the suspension elements, the suspension element comprising an intermediate support and in which the camber means comprise at least one curved slider that connects the wheel support to the intermediate support. In fact, this support system replaces the rigid wheel support of the prior art. It has the function of articulating the wheel plane relative to the known suspension elements. “Suspension elements” means those elements that take up the load by allowing the generally vertical deflection of the wheel, such as arms, springs, shock absorbers or anti-roll connections.

Preferably, the curved slider is a circular slider comprising at least one ball bearing, disc bearing and/or roller bearing.

The support system of the invention is such that, for the said wheel of radius ‘r’ designed to be in contact with the ground via a contact patch, the said camber means are configured such that the wheel has a first instantaneous center of rotation about a mean position, which is located within a range between 2.5r above ground and r below ground and preferably between 0.5r above ground and r below ground, more preferably still below the plane of the ground.

More preferably still, the said first instantaneous center of rotation is located transversely under the said contact patch.

According to one embodiment, the support system is configured such that it is close to equilibrium in the mean position in the absence of any transverse force exerted by the ground on the wheel in the contact patch. This equilibrium can be an unstable equilibrium.

Preferably, the first instantaneous center of rotation is located essentially in the wheel plane (PR).

Preferably, the intermediate support consists of one of the suspension elements, for example a strut of a MacPherson suspension system.

The support system according to the invention can also comprise control means able to influence the camber of the wheel. These control means may comprise an elastically deformable element that opposes the camber movement.

The invention also relates to a suspension system for a vehicle comprising the support system described above.

This suspension system, which is designed to connect a wheel support to a vehicle body, the wheel support being designed to carry a wheel of radius ‘r’ and the wheel being designed to rest on the ground via a contact patch, comprises means that confer upon the wheel support, relative to the body, a degree of freedom of camber and a degree of freedom of suspension deflection which are independent of one another, the suspension system being configured such that the camber movement of the wheel support relative to the body has a second instantaneous center of rotation about a mean position, located within a range between 0.5r above ground and r below ground. The suspension system of the invention comprises two degrees of freedom that allow essentially independent suspension and camber movements. The camber movement of the wheel (or wheel support) takes place around a second instantaneous center of rotation located a limited distance away from the contact patch so as to limit track variations during the camber or reverse camber movement and to limit the energy input required in the case of active camber control.

In a preferred embodiment, the said second instantaneous center of rotation is located within a range from 0.2r above ground to 0.4r below ground and more preferably still 0.1r above ground to 0.3r below ground.

To ensure stable operation, the system is preferably configured such that it is close to equilibrium in the said mean position in the absence of any transverse force exerted by the ground on the wheel in the contact patch, and more preferably still, configured such that in the absence of camber variations, the transverse force exerted by the ground on the wheel in the contact patch generated during a suspension deflection does not exceed a limit corresponding to 0.3P, where “P” is the weight of the vehicle.

To allow passive operation the said second instantaneous center of rotation of the movement of the wheel support relative to the vehicle body may preferably be located below ground level so that transverse forces exerted by the ground on the wheel in the contact patch induce an inclination of the wheel support relative to the body in the direction of decreasing camber when the said transverse forces are directed towards the inside of the vehicle and in the direction of increasing camber when the said transverse forces are directed towards the outside of the vehicle. In the case of passive operation related to the transverse forces, the system may comprise means to measure the camber movement of the wheel support in order to deduce the said transverse forces from it.

Under certain conditions it may be necessary or advantageous to provide in addition control means that can influence the wheel camber. These means may comprise an elastically deformable element which opposes the cambering movement, the said deformable element consisting for example of a metallic or elastomeric spring.

Preferably, the said degree of freedom may be controlled by active means as a function of running parameters of the vehicle.

Finally, the invention concerns a vehicle equipped with such a suspension system.

Several embodiments of the invention will be described in order to illustrate its characteristics and explain its principles. Naturally, numerous other embodiments of the invention are possible, as suggested by the many variants illustrated.

### DESCRIPTION OF THE DRAWINGS

FIG. 1 is a schematic longitudinal view showing the principle of a support and suspension system according to the invention.

FIG. 2 is a sectional view of a support device according to a first embodiment of the invention.

FIG. 3 is a partial cross-sectional view of the device of FIG. 2.

FIG. 4 is a sectional view of the device of FIG. 2 when it is subjected to a transverse force directed toward the inside of the vehicle.

FIG. 5 is a sectional view of the device of FIG. 2 when it is subjected to a transverse force directed toward the outside of the vehicle.

FIG. 6 is a partial cross-sectional view of a second embodiment of the support device according to the invention.

FIG. 7 is a radial sectional view of a first embodiment of a slider according to the invention.

FIG. 8 is a cross-sectional view of the slider of FIG. 7.

FIG. 9 is a radial sectional view of a second embodiment of a slider according to the invention.

FIG. 10 is a cross-sectional view of a third embodiment of a slider according to the invention.

FIG. 11 is a cross-sectional view of a fourth embodiment of a slider according to the invention.

FIG. 12 is a cross-sectional view of the slider of FIG. 11.

FIG. 13 is a sectional view of a suspension system according to another embodiment of the invention.

FIG. 14 is a sectional view of a vehicle according to the invention.

FIG. 15 is a schematic illustration of the principle of a support and suspension system according to another embodiment of the invention.

FIG. 16 is a view similar to that of FIG. 1, of a further variant of the invention.

### DETAILED DESCRIPTION OF THE INVENTION

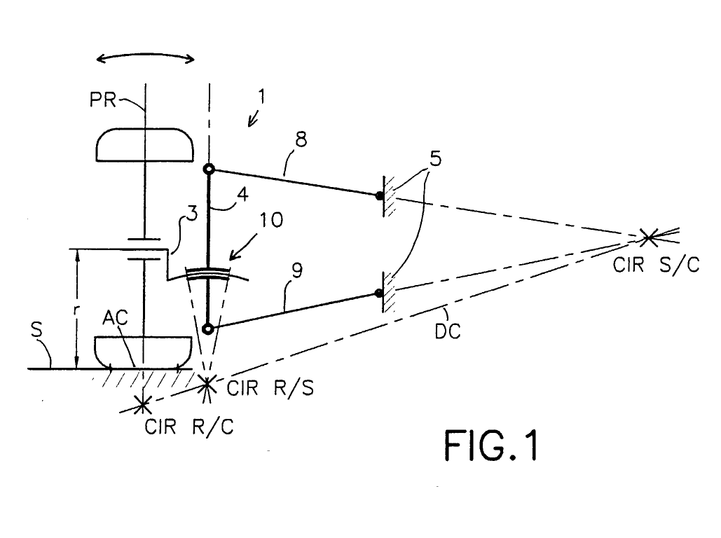

FIG. 1 is a planar longitudinal view showing the principle of a suspension system according to the invention. This planar (i.e. 2-dimensional) representation is very convenient because it shows clearly how the system according to the invention differs from those of the prior art.

The suspension system 1 comprises a wheel support 3 designed to maintain the plane PR of a wheel 2 relative to the body 5 of a vehicle. The wheel, of radius “r”, rests against the ground S on its contact patch AC. The wheel support 3 is connected to the body 5 by means (4, 8, 9, 10) that allow it two degrees of freedom. In effect, the wheel support 3 is attached to the intermediate support 4 by a curved slider 10 which allows a camber movement of the wheel support 3 and hence the wheel 2 relative to the suspension elements (4, 8, 9) depicted in this particular embodiment of the invention. As for the suspension deflection movement, this is allowed in a known way by an intermediate support 4 linked to the body 5 via upper 8 and lower 9 arms (or triangles). Thus, the suspension system 1 is configured so as to confer on the wheel support 3, relative to the body 5, a degree of camber freedom since the wheel support can tilt relative to the body, and a degree of freedom of suspension deflection since the wheel support can undergo essentially vertical movements in a manner known as such, for example in the manner of “multi-arm” or “double wishbone” systems. These two degrees of freedom are independent. In effect, the suspension movements can take place with no consequence for the camber movement, and vice-versa.

The movement of the wheel support 3 or of the wheel plane PR relative to the intermediate support 4 has a first instantaneous center of rotation (CIR R/S) which corresponds to the center of curvature of the curved slider 10. This center of curvature may be fixed (unique) if the slider is circular, or variable as a function of the position of the slider if the curvature of the slider is not constant.

The camber movement of the wheel support 3 relative to the body 5 has a second instantaneous center of rotation (CIR R/C) whose position will now be determined.

The suspension deflection movement of the intermediate support 4 relative to the body 5 of the vehicle has a third instantaneous center of rotation (CIR S/C), which is determined at any time by the geometry of the upper and lower arms that connect the intermediate support 4 to the body 5.

Applying the classically accepted hypothesis that the wheel 2 contacts the ground S at a point, the theory of colinearity of instantaneous centers of rotation in a planar movement enables the second instantaneous center of rotation (CIR R/C) of the camber movement to be located at the intersection of the wheel plane PR and the line DC on which the first (CIR R/S) and third (CIR S/C) instantaneous centers of rotation are located. This kinematic theory is commonly used in the field of suspension systems. It is then understood that it is the choice of the geometrical configuration, i.e. the dimensions and orientation of the various elements constituting the suspension system which (by determining the positions of the characteristic axes and points) enables a desired position to be obtained for the second instantaneous center of rotation (CIR R/C) of the camber movement of the wheel relative to the body under the action of transverse force. FIG. 1 shows the suspension system in a mean position, which could be defined as the position corresponding to rolling in a straight line over flat ground (S) when the vehicle is carrying its normal load. The static camber is shown here as essentially zero. FIG. 1 shows the kinematic operation of the system according to the invention. Static equilibrium of the forces undergone by the system (vehicle weight, force from the ground acting on the wheel, suspension springs) must of course be ensured by the design of the system. The vertical load applied to the suspension elements is absorbed in a known way by a spring located between the body 5 and the intermediate support 4, or one of the arms or wishbones (8, 9). To control the static camber angle, the position of the wheel support 3 relative to the intermediate support 4 or the body 5 can also be influenced by an additional elastic element (not shown). The support system of the invention comprises the wheel support 3 and the slider 10, and constitutes part of the suspension system of the invention.

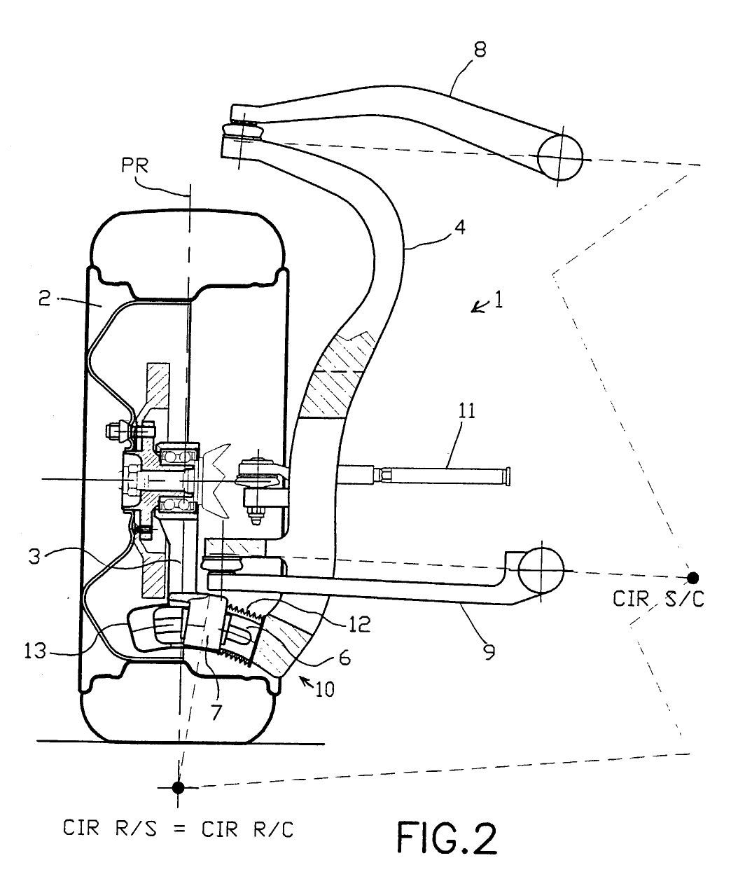

FIG. 2 is a section in a vertical plane through the axis of the wheel 2, showing an embodiment of the support and the suspension system (1) of the invention. The intermediate support 4 is connected to the body by an upper arm (or triangle) 8 and by a lower arm (or triangle) 9 which allow the wheel 2 to undergo its suspension deflection movement. The wheel support 3 is connected to the intermediate support 4 by a slider 10. This slider comprises a guide 6 curved in a circular arc and attached to the intermediate support 4, and a guided element 7 attached to the wheel support 3. Thus, the first instantaneous center of rotation (CIR R/S) of the movement of the wheel support 3 relative to the intermediate support 4 is fixed relative to the latter and corresponds to the position of the center of curvature of the circular guide 6. Moreover, in this particular embodiment the said first instantaneous center of rotation is located under the contact patch AC and essentially in the wheel plane PR. By virtue of the principle of colinearity mentioned earlier, the second instantaneous center of rotation for the camber (CIR R/C) coincides with the first, since it is also located in the wheel plane.

This preferred configuration gives perfect equilibrium from the standpoint of camber because the suspension system is at equilibrium in its mean camber position in the absence of any transverse force exerted by the ground S on the wheel in the contact patch. In practice, bearing in mind the rigidity of the tire, a configuration close to this theoretical equilibrium may be satisfactory in operational terms. Experiments have shown that when the position of the first instantaneous center of rotation (CIR R/S) relative to the center of the wheel forms an angle smaller than 15° with the wheel plane PR, this condition can be satisfied.

As discussed above, the static equilibrium is perfect when the first instantaneous center of rotation (CIR R/S) is located in the wheel plane if the theoretical case where no stiffnesses are taken into account. However, the dynamic equilibrium, that is to say the equilibrium of the system when the vehicle is driving, can be influenced by forces originating in the tire rolling motion. For example, it is well known that, because of its design or construction; a rolling tire develops a transverse force (tire pull). The amount of this force is generally related to the rotational speed of the tire. Thus, the static location of said first instantaneous center of rotation (CIR R/S) can be chosen to be at a distance of several millimeter's from the wheel plane in order for the tilting torque generated by the vertical load to compensate for the tilting torque generated by the transverse force (pull), at least for a given rotational speed.

FIG. 2 also shows view of the wheel-side end of a transmission (partially) as well as a track rod 11 that controls the orientation of the intermediate support 4 about the pivot axis constituted by the points where the arms 8 and 9 are connected to the intermediate support 4. Having regard to this example of a wheel that both drives and steers, it is clear that the invention can be applied to any combination, whether the wheel is a front or rear wheel, a drive wheel or not, and a steering wheel or not of the vehicle. In this example the slider 10 is isolated by a bellows 12 and a cap 13 to protect it from the outside, in particular from dust, humidity and the thermal environment.

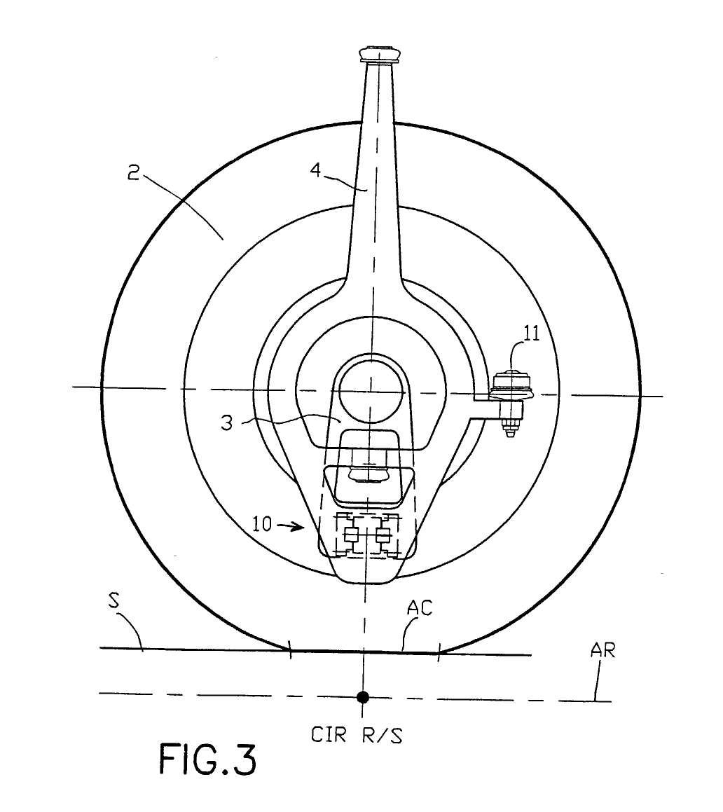

FIG. 3 shows the specific elements of the suspension system of FIG. 2 viewed transversely to the vehicle, i.e. in projection along the wheel axis. These elements are the wheel support 3 and the curved slider 10 connecting the wheel support 3 to the intermediate support 4. The shape of the intermediate support 4 must confer good rigidity upon it while, if needs be, allowing the presence of a transmission (not shown in this view) and the steering deflection in relation to the lower arm or triangle 9 (also omitted in this figure). Similar constraints govern the design of the wheel support 3. The slider 10 is in this case indicated only schematically by its profile, to facilitate an understanding of the figure. The axis AR of the wheel support's rotation relative to the intermediate support has been shown. This axis is the axis of the slider's curvature. The axis AR is fixed relative to the intermediate support 4 and the wheel support 3 when the slider 10 is circular as is the case in this embodiment of the invention. The orientation of the axis AR, shown as horizontal in the figure, may be inclined if it is desired to obtain other effects associated with the camber, as explained later on.

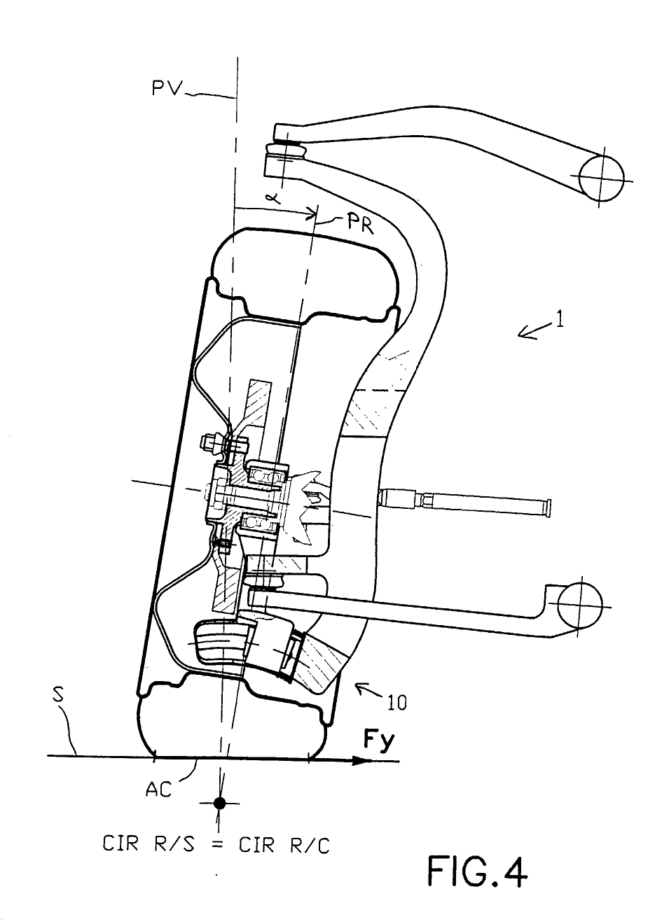

FIG. 4 shows the embodiment of FIG. 2 when the wheel 2 is subjected in the contact patch AC to a force whose transverse component Fy is directed towards the inside of the vehicle. This is the case of a wheel on the outside of a curved path followed by the vehicle. The fact that the second instantaneous center of rotation (CIR R/C) of the camber movement is located below the plane of the ground S implies that the component Fy generates a couple which tends to pivot the wheel support (and hence the wheel plane PR) towards the inside of the curve. This rotation takes place in the direction of reverse camber (i.e. the camber angle decreases, tending towards negative values).

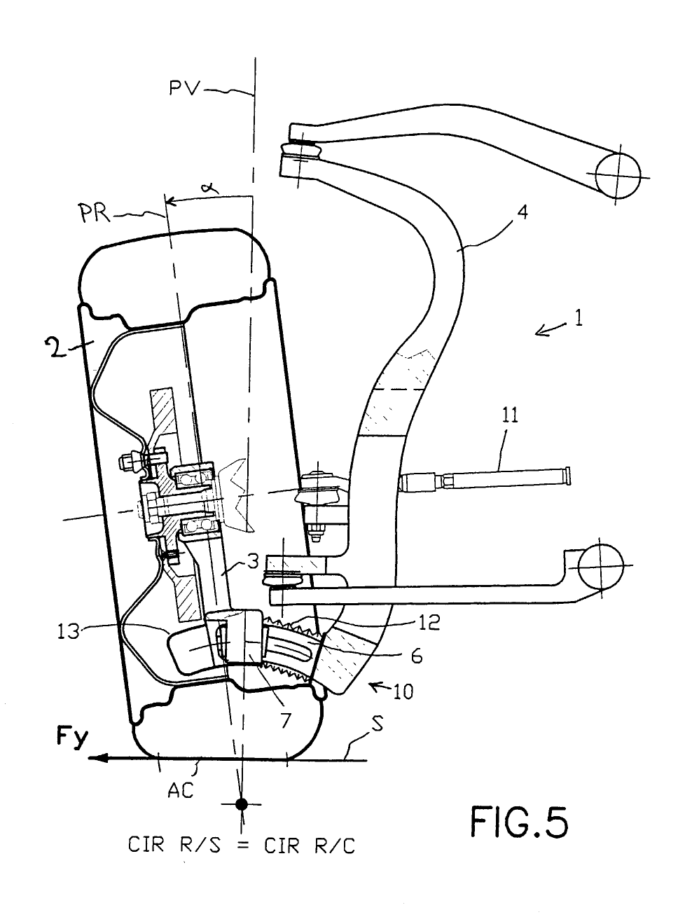

Conversely, as shown in FIG. 5, when the wheel 2 is subjected in its contact patch AC to a force whose transverse component Fy is directed towards the outside of the vehicle (as in the case of a wheel on the inside of a curved path followed by the vehicle), the component Fy generates a couple which tends to pivot the wheel support in the direction of increasing camber (i.e. the camber angle increases, tending towards positive values). Comparing these two figures makes clear the camber movement of the wheel or wheel support that is allowed by the invention. The isolation function ensured by the bellows 12 and the cap 13 is also apparent. These protection means may have a supplementary function, that of offering some resistance to the camber movement. In effect, the bellows may constitute or integrate a spring or abutment in order to influence or limit the movements of the wheel support 3 relative to the intermediate support 4. Accordingly, the bellows may constitute a control means capable of influencing the camber of the wheel. Similarly, a deformable element or an abutment can be integrated in the cap 13 for the same purpose.

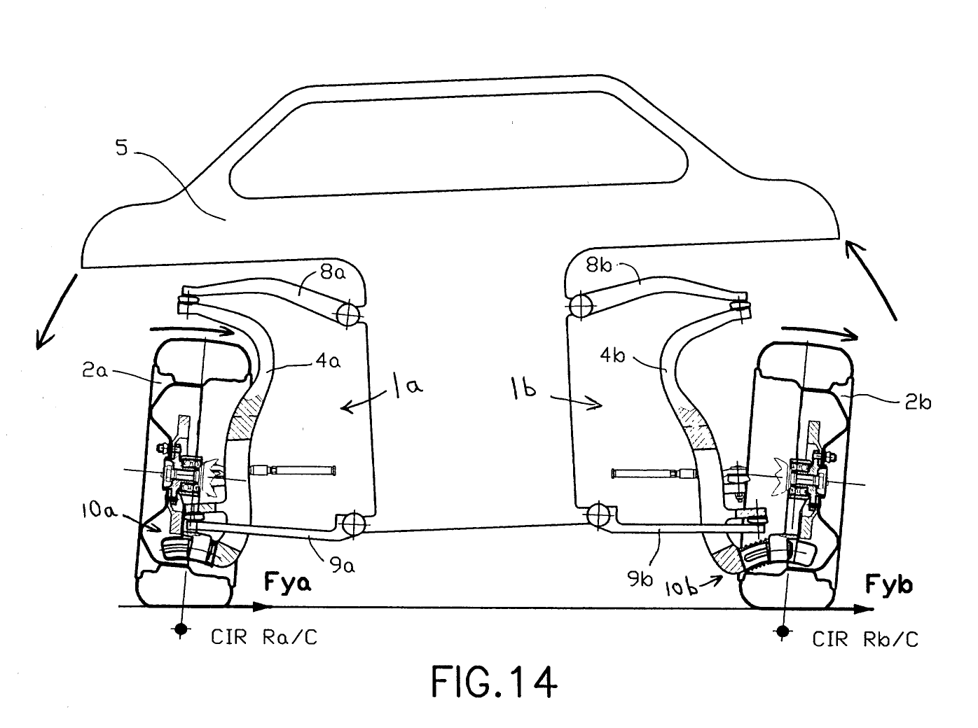

For convenience, FIGS. 4 and 5 show the variation of the wheel camber produced by a transverse force Fy in the case of a vehicle whose body remains immobile. This camber variation is directly related to the operation of the support system. In reality, on most current vehicles a transverse force also causes the body to roll. Rolling is a suspension deflection movement which is opposite for each wheel of the axle, which makes the body incline towards the outside of the bend. This inclination of the body also tends to tilt the wheel plane towards the outside of the bend (see above). In that case, the inclination of the wheel produced by roll is of course in the direction opposite to the camber shown in the figures. Thus, strictly speaking the variation illustrated in FIGS. 4 and 5 should be considered as relative to the body, i.e. relative to the plane PV connected with the body. To determine the position of the wheel relative to the ground, the variation induced by roll (and also by the deformation of the various elements of the ground contact system) must be integrated as well. This situation is represented in FIG. 14.

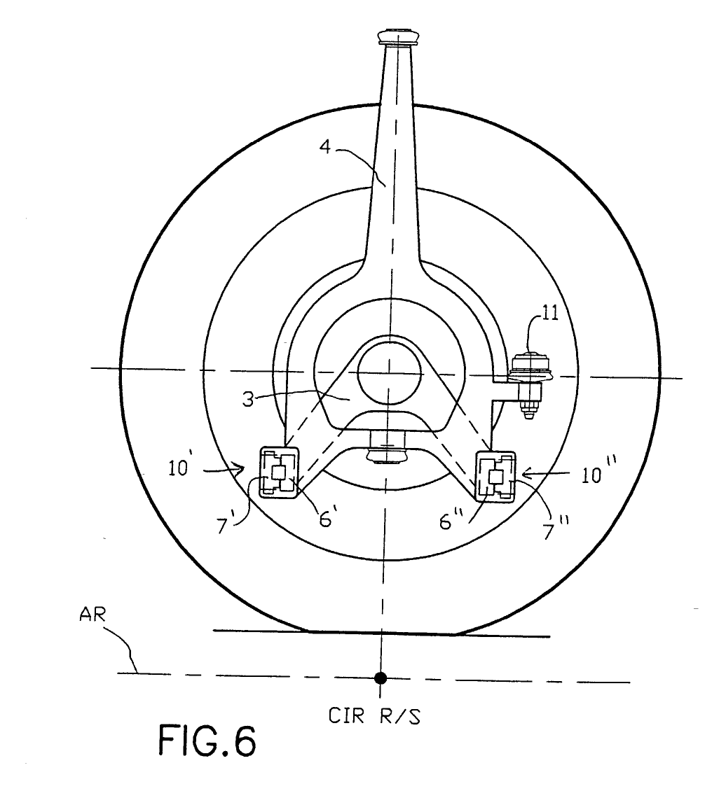

FIG. 6 shows a second embodiment of the system shown in FIGS. 2 to 5, represented in a view identical to that of FIG. 3. The difference from the embodiment described above is in the articulation of the wheel support 3 relative to the intermediate support 4. In effect, this embodiment comprises two distinct and separated curved sliders (10′, 10″). Each of these sliders consists of a guide (respectively 6′ and 6″) and a guided element (respectively 7′ and 7″). The two guides 6′ and 6″ have identical curvature in this example. They are circular guides whose curvatures have a common axis AR. The wheel support 3 is therefore attached to the intermediate support 4 by a pivot joint along the axis AR in the same way as in the first embodiment. Advantageous consequences of this duplicated structure can be the reduction of stresses applied to the sliders, rigidity in the guiding of the wheel, increased road grip or a reduction of the overall radial dimensions.

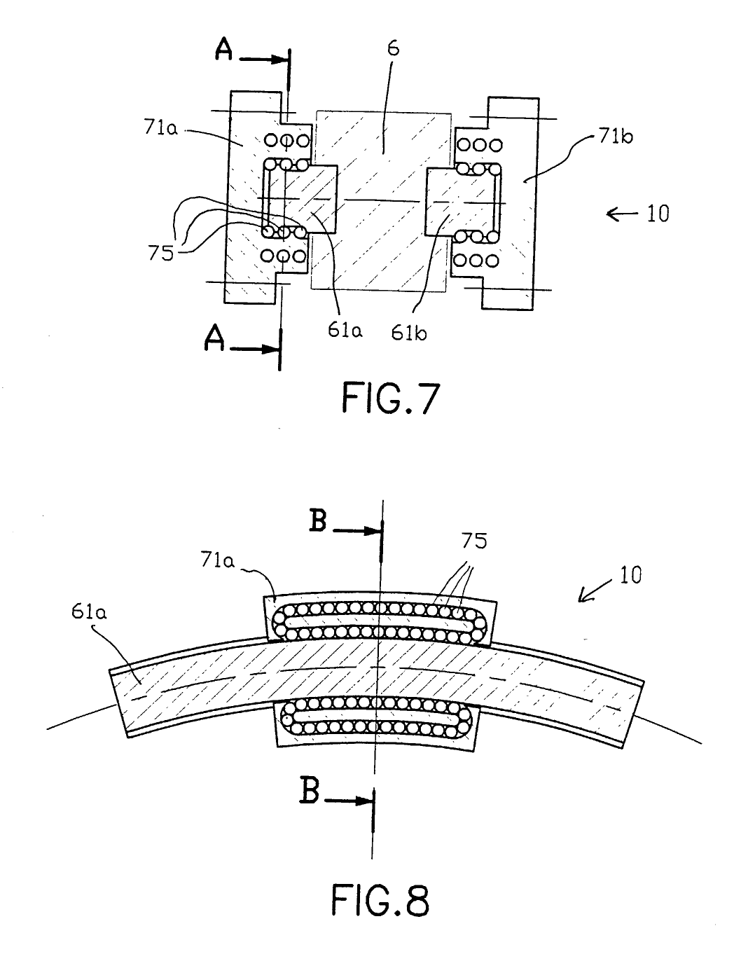

Naturally, the sliders may be single, as described and illustrated in FIG. 6, or double, in other words comprising two guided elements arranged opposite one another as in FIG. 3. This double-slider configuration is shown in FIGS. 7 to 9.

FIGS. 7 to 12 shows several examples of sliders that can be used in the support system of the invention. A person with knowledge of sliders and bearings will know how to design other forms of sliders that could be used in the context of the invention.

FIG. 7 is a radial sectional view (along the plane B-B in FIG. 8) of a curved slider that could be used according to the invention to attach the wheel support to the intermediate support. The guide 6 comprises a rail 61a and a rail 61b fixed on either side. Preferably, the guided elements are carriages 71a and 71b which run along the rails on balls 75 that move in ball races. In this case three parallel ball races have been shown for each carriage. A person with knowledge of bearings will be able to design and dimension such sliders as a function of the forces and operating conditions involved. The single sliders represented in FIG. 6 can consist of half the double system shown in FIG. 7.

FIG. 8 is a sectional view (along A-A in FIG. 7) in the plane of a ball race. This shows clearly the principle of the guiding of the carriage 71 a relative to the rail 61 a thanks to the circulation of the balls 75. The curvature of the rail 61 a determines the path of the carriage relative to the guide 6 and it is clear that the center of this curvature constitutes the center of the relative rotation. The curvature shown here is constant, so that the center of rotation is fixed. However, if the rail is not circular, the carriage will rotate relative to the guide 6 about an instantaneous center of rotation whose position varies. In that case the carriage must of course be able to operate on a variable radius.

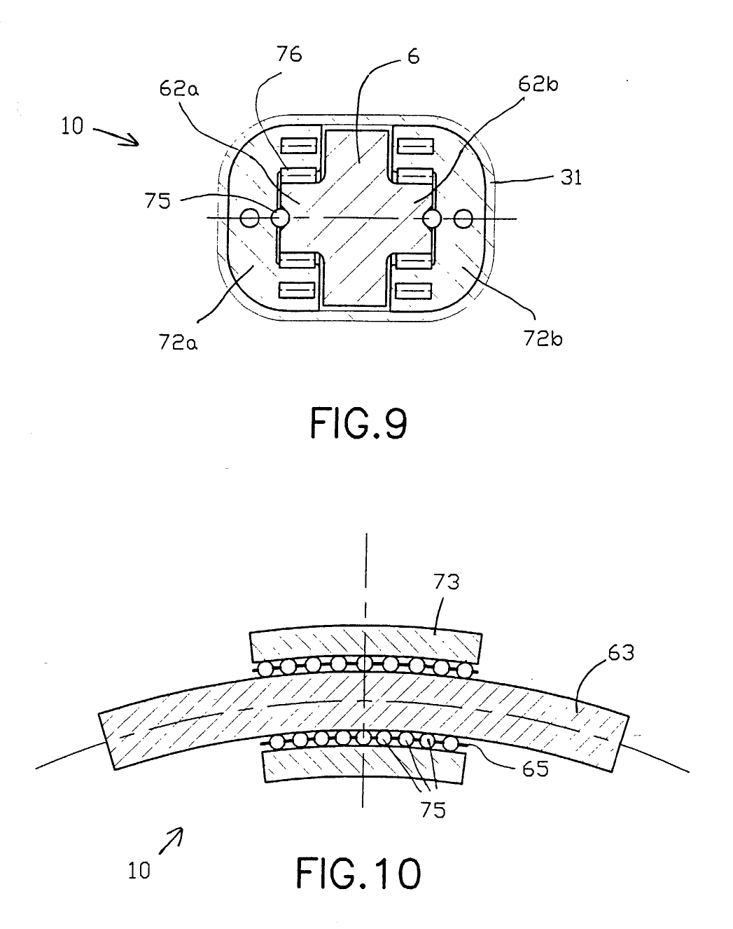

FIG. 9 shows a sectional view similar to that of FIG. 7, of another embodiment of a double slider. In this example the guide 6 is made in one piece with the rails 62a and 62b. The carriages 72a and 72b are guided radially by a circulation of rollers 76 and laterally by a circulation of balls 75. A casing 31 enables the carriages to be connected to the wheel support 3. This may be integral with the wheel support or attached thereto by any means. The casing 31 can also be responsible for part of the sealing that is desirable for proper operation of the slider.

FIG. 10 is a sectional view similar to that of FIG. 8, of another embodiment of a single or double slider in which the relative movement of the carriage 73 with respect to the rail 63 is allowed by the interposition of a cage 65 with ball 75 or roller bearings. In the case of ball bearings the section of the rail can be round if at least two rails are used per wheel. If rollers are used, the rail and the carriage will preferably have cylindrical rolling surfaces as in the example of FIG. 9. To guarantee the positioning of the cage during the movement, the pre-stress must be sufficient to prevent any sliding. Alternatively the position of the cage can be controlled by abutments or by any indexing means so that any displacement of the cage is prevented or corrected as necessary.

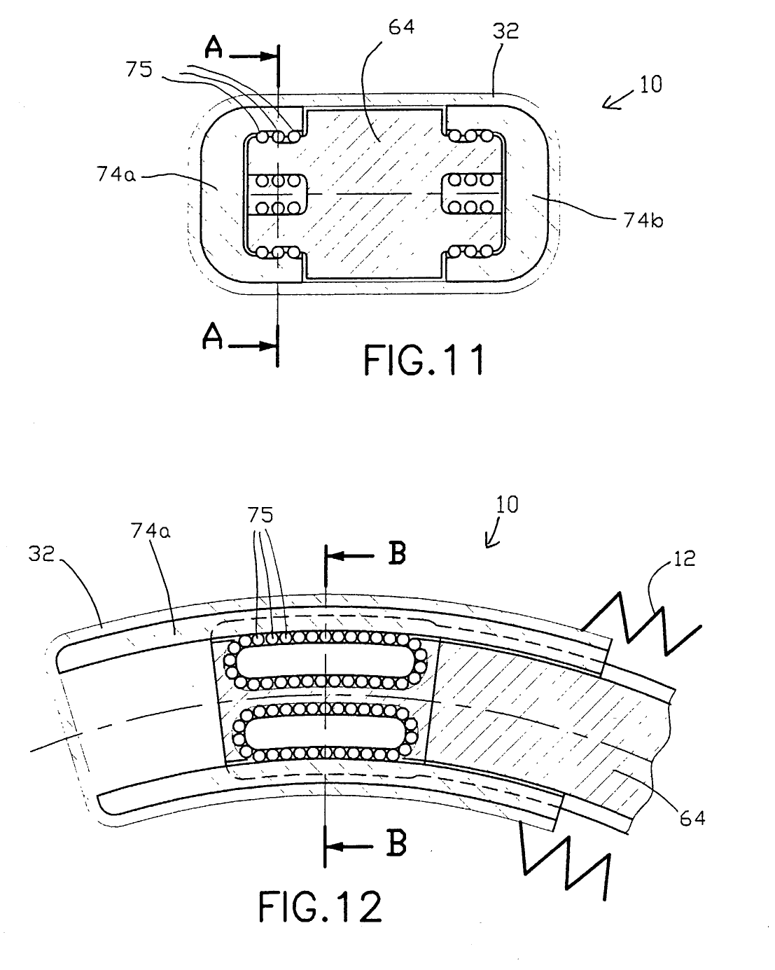

Another embodiment of the slider is shown in FIGS. 11 and 12. FIG. 11 is a radial sectional view (plane B-B in FIG. 12) of a curved slider that can be used according to the invention to attach the wheel support to the intermediate support. This embodiment operates in the inverse way compared with those described earlier. In effect, the male element 64 in this case carries the circulation system of the balls 75 in a manner similar to the carriages described earlier, while the female elements 74a and 74b carry the ball rolling tracks and therefore constitute the hollow rails. Three ball tracks have been shown here for each carriage. A person with knowledge of bearings will be able to design and dimension such sliders as a function of the forces and operating conditions involved.

FIG. 12 is a sectional view (along A-A in FIG. 11) in the plane of a ball track. In this, the principle of the guiding of the male element 64 relative to the rail 74a thanks to the circulation of the balls 75 is clearly apparent. The curvature of the rail 74a defines the path of the male element 64. Clearly, the center of that curvature constitutes the center of the relative rotation. In this case a circular curvature has been shown, such that the center of rotation is fixed. The casing 32 enables the rails 74a and 74b to be connected to the wheel support 3. It can be integral with the wheel support or attached thereto by any means. This casing 32 can also be responsible for part of the sealing that favours the proper operation of the slider in co-operation with the bellows 12 in the manner described for FIG. 2.

FIGS. 7 to 12 illustrate the fact that the slider or sliders can articulate the wheel support relative to the intermediate support in an infinite number of possible configurations. In particular, the question of knowing which part of the slider is connected to the wheel support and which other part is connected to the intermediate support is a matter of optimising the mechanical design as a function of the vehicle's characteristics.

However, the slider function can naturally be ensured by any sliding mechanism. For example, the male portion of the slider can be adjusted for sliding in the female portion. A very smooth surface condition combined with a treatment known as such (Teflon™, Xylan™ or other polymers that can be used for the same purpose) and/or lubrication (oil, grease) can allow the desired function to be obtained. The cross-section of the slider is then preferably rectangular to ensure guiding along the different directions and to allow simple machining.

This manner of constructing the slider 10 may be preferred to the use of a bearing from the standpoint of space occupied. In effect, the space available in particular between the wheel rim and the brake disc is limited. From the standpoint of robustness too, a “sliding” solution has the advantage of a larger contact patch compared with balls or rollers, and therefore less sensitivity to scoring.

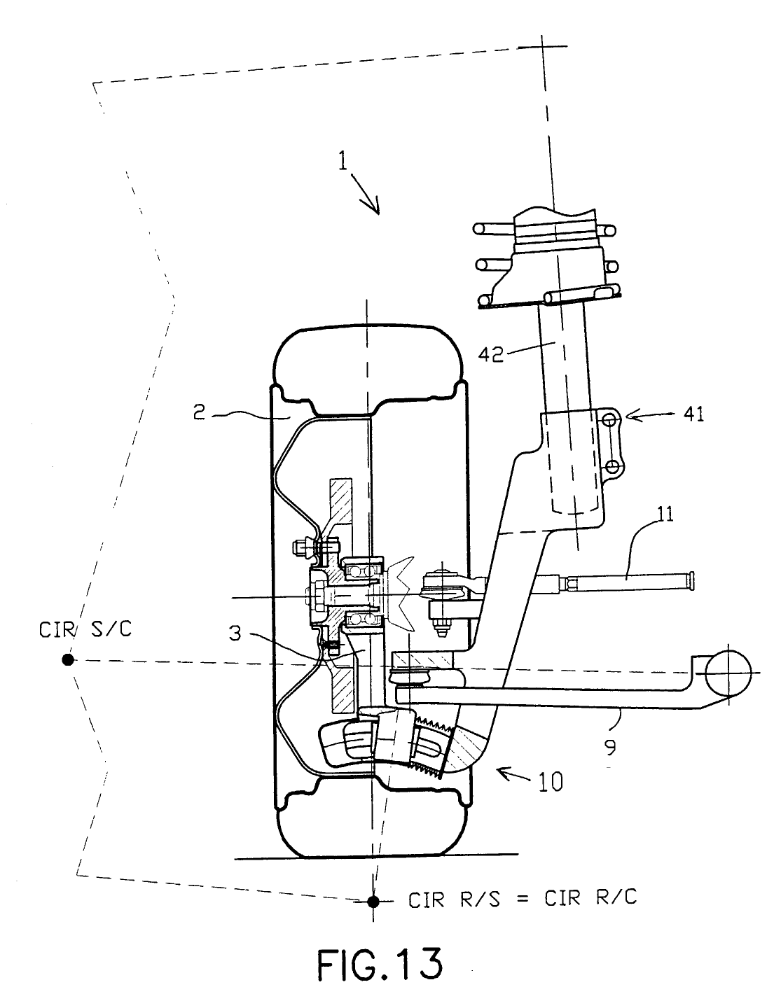

FIG. 13 shows another embodiment of the suspension system according to the invention. In this example the suspension deflection movement is enabled by a MacPherson strut 41 and a lower arm or triangle 9 in a manner known as such. To this strut is articulated a wheel support 3 via a curved slider 10, for example identical to that described in FIG. 2. In this embodiment the strut 41 constitutes the intermediate support 4 of the previous figures. By analogy with the kinematic analysis of FIG. 1, the suspension deflection movement of the strut 41, relative to the body of the vehicle, has a third instantaneous center of rotation (CIR S/C) at the intersection of the lower arm or triangle 9 and the normal to the axis of the jack 42 of the strut 41. As in FIG. 2, a circular slider has been shown.

Since the geometry differs from that of FIG. 2 only in the position of the third instantaneous center of rotation (CIR S/C), the kinematic analysis of the cambering function of this suspension system leads to the same findings as those described for FIGS. 2 to 5. This figure illustrates clearly the fact that the support system of the invention can be used in relation to most suspension systems since it operates mainly to allow an extra degree of freedom between the wheel support and the “suspension” in the classical sense of the term. In relation to the suspension, the intermediate support 4 carries out the same function as the wheel support in the prior art.

FIG. 14 represents schematically a vehicle equipped on at least one of its axles with a suspension system according to the invention. Considering that the view shown is from the rear, this situation corresponds to the case when the vehicle is rounding a bend to the right. The body 5 of the vehicle then rolls in an entirely familiar way towards the outside of the bend, i.e. the body tilts to the left. The wheels 2a and 2b respectively experience transverse forces Fya and Fyb directed towards the inside of the bend, i.e. towards the right in the figure. When the instantaneous centers of rotation (CIR Ra/C and CIR Rb/C) of the camber movements of the wheels 2a and 2b relative to the body 5 are located below the ground S, these forces Fya and Fyb generate an inclination of the wheels relative to the body towards the inside of the bend as described in FIGS. 4 and 5. This inclination is opposite to the one induced by the roll. Thus, the roll can be compensated in part, in full or in excess. The extent of this passive compensation is of course a function of the configuration adopted, i.e. the position of the instantaneous centers of rotation and the stiffness that oppose movement. The case illustrated corresponds to compensation that is largely excessive since, despite the roll of the body, the wheels are clearly inclined towards the inside of the bend.

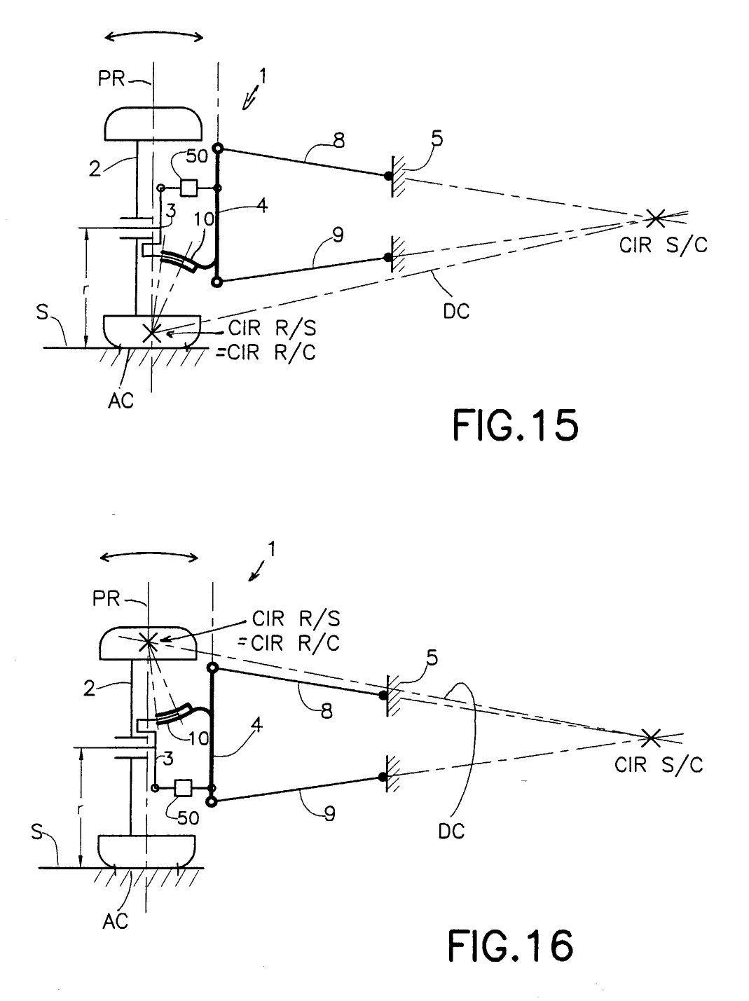

Using the same type of schematic representation as FIG. 1, FIG. 15 describes another particular geometry of support and suspension systems according to the invention. In this example the slider 10 determines a rotation of the wheel support 3 relative to the intermediate support 4 about an instantaneous center of rotation (CIR R/S) located essentially in the wheel plane PR and above the ground S. Under the conditions and in accordance with the kinematic principles discussed earlier, the second instantaneous center of rotation (CIR R/C) coincides with the first one and since its position is above ground, the transverse forces applied to the wheel at the level of the contact patch AC tend to tilt the wheels in the opposite way to the effect sought by the invention. The operation of such a geometry must therefore be controlled in an active way by a control means for influencing the camber of a wheel, for example by jack 50. The means 50 of active control preferably acts between the intermediate support 4 and the wheel support 3 as illustrated, and may be controlled as a function of vehicle driving parameters. Naturally, this alternative is not limited to the case of FIG. 15 but can be adapted to any other embodiment.

In the case of active control the position of the second instantaneous center of rotation (CIR R/C) of the camber movement is advantageously located at ground level S or above it, but at a small distance in order to enable low-energy control and so as to limit the half-track variation caused by the movements of the wheel plane.

FIG. 16 shows a configuration which differs from the suspension system of FIG. 15 in a manner that allows direct graphical comparison. In effect, the system of FIG. 16 is configured such that the camber movement takes place around a point located in the upper part of the wheel plane PR. In accordance with the same principles discussed earlier, the position of the instantaneous center of rotation (CIR R/C) of the wheel 2 relative to the body 5 can be determined. An advantage of this configuration is that less space is involved during the camber deflection at the level of the upper part of the wheel. In effect, in this example the wheel plane rotates about a point (CIR R/C) located close to or even in the section of the upper part of the wheel 2. Thus, during cambering, the upper part of the wheel 2 hardly moves at all relative to the body and accordingly relative to the wing or the wheel arch of the vehicle body. Only the vertical suspension deflection need then be taken into account in the design of the body. Another advantage of the active configurations of FIGS. 15 and 16 concerns the half-track variation during the camber movements. If, in a situation such as a bend to the right (as represented in FIG. 4), the active control means 50 imposes a negative camber on the wheel 2, this camber movement taking place about a point (CIR R/C) located above the ground S, the bottom of the wheel (and thus the contact patch) is shifted (relative to the body) towards the outside of the bend. This corresponds to what is known as a positive half-track variation. This characteristic can be advantageous for the stability of the vehicle's handling and has the advantage of counteracting the load transfer by a displacement of the center of gravity of the body 5 towards the inside of the bend. Thus, the overload of the outer wheel compared with the wheel on the inside of the bend is reduced, a factor that is positive for the overall grip of the axle.

As has been seen, depending on the function desired a position is chosen for the first instantaneous center of rotation (CIR R/C) of the camber degree of freedom, preferably within a range between r above ground and r below ground (r being the radius of the wheel). The fact that this point is positioned near the ground enables the track variation to be limited. For example, in the case of a first instantaneous center of rotation located a distance “r” from the ground and with a wheel of radius 300 mm, a camber angle of 50 brings about a displacement of the contact patch relative to the body (i.e. a half-track variation) of about 25 mm. It has been found that this value should be regarded as a limit which must not be exceeded. However, when the first instantaneous center of rotation CIR R/C) of the camber degree of freedom is located above ground, i.e. when the system according to the invention has to comprise an actuator to orientate the camber of the wheel plane actively (see the description of FIGS. 3 and 4 earlier), tests have shown that above a certain height the power required for this active operation makes the system's energy consumption too large. This limiting height has been found to correspond essentially to a wheel radius. Still more advantageously in terms of the energy required and the size of the track variation, the position of the first instantaneous center of rotation (CIR R/C) of the camber degree of freedom is located at ground level S or above that level but at a smaller distance, for example a distance corresponding to 0.1r.

In contrast, if the energy criterion is not preponderant, it may be preferred to implement the invention with the kinematic conditions described in FIG. 16. In this case the instantaneous center of rotation (CIR R/C) is advantageously located within a range from r to 2.5r above ground, preferably between 1.5r and 2r, in order to allow the minimum space to be needed under the wings of the vehicle.

It will be understood that depending on the relative importance of the various criteria, a compromise can be determined between the space occupied, the energy required and the mechanical design constraints, and that this compromise will correspond to a certain height of the instantaneous center of rotation (CIR R/C) of the wheel's camber movement relative to the body within the range described, between r below ground and 2.5r above ground. For example, a position of the instantaneous center of rotation (CIR R/C) very close to the level of the wheel axis enables a transmission, if present, to operate under nearly conventional conditions. On the contrary, the further away this pivoting point is from the center of the wheel, the larger will be the distance variations between the body and the wheel support during camber movements and this will impose additional design constraints as regards transmissions.

When control means for influencing the camber of the wheel are provided in a system with passive configuration (for example that of FIG. 1), its purpose can be to regulate the camber movements induced passively and in the direction brought about by the transverse forces, as explained in relation to FIGS. 4 and 5. The control means can then take the form of a camber damper or a spring whose action tends to limit the inclination or to maintain a given camber angle in the absence of any lateral force Fy.

Whether it is active or passive, if the control means for influencing the camber of a wheel can be piloted it can be controlled as a function of various vehicle driving parameters (for example speed, longitudinal or transverse acceleration, steering wheel position, steering wheel rotation speed, torque exerted on the steering wheel, roll, roll speed, roll acceleration, yaw, yaw speed, yaw acceleration, force on the wheels including vertical load, type of driving or handling desired by the driver).

The control means (represented schematically in FIGS. 15 and 16 by a telescopic jack 50) may take various forms. For example, it is possible to use telescopic or rotary, hydraulic or electrical jacks, linear motors, screw systems driven by electric or hydraulic motors or asynchronous, self-piloting electric motors. Naturally, the various types of control means can be freely combined in the various possible configurations of the system of the invention, although for various reasons such as cost or robustness some of these combinations are particularly advantageous.

The control means may also be integrated in the slider 10, for example in the form of a rack-and-pinion assembly driven by an electric motor.

According to a similar design, the control means may include means to measure the camber movement. In the case of camber movements induced by transverse forces, this measurement can be used to determine the forces by means of methods known as such. Similarly, in configurations which use active control means it is possible in a manner known as such to measure the force transmitted by the active control means and deduce from it the transverse forces exerted on the wheel in the contact patch. This information is useful for example, for the piloting of safety systems or systems that regulate the handling of the vehicle and naturally, if needs be, for piloting the camber control means.

In the case of passive operation such as described earlier, one way of checking the operation of the system according to the invention (and measuring its sensitivity) is to exert a transverse force (for example with the aid of a ball plate) at the level of the contact patch of the wheel of a vehicle fitted with the system according to the invention, and to measure the variation of the camber angle.

An interesting feature of the invention is that it can be applied to any known suspension system since the principle of the invention is to add to these existing systems supplementary elements that allow a degree of camber freedom in addition to the existing degree of freedom of the suspension deflection. An advantage of these support and suspension systems is their compactness, which makes it possible not to have to redesign current vehicles. Moreover, the use of a curved slider enables the center of this rotation to be positioned at any point of the plane and in particular near the ground or even below ground level. Another advantage of the invention is that it allows a variation of the camber of each wheel independently of the vehicle's other wheels and regardless of whether the wheel is a drive and/or a steering wheel.

FIGS. 1, 2, 4, 5, 13, 14, 15 and 16 illustrate the principles and several embodiments of the invention, represented in projection on a plane perpendicular to the ground and transverse to the vehicle passing through the point of application of the resultant of the forces in the contact patch. This two-dimensional representation is advantageous for illustrating clearly the essential characteristics of the invention, whose objective is a controlled variation of the camber. In this representation the camber movement is a rotation in the plane about a pivot point (instantaneous center of rotation). However, it must not be forgotten that a rotation takes place in reality (thus in three dimensions) about a real or virtual pivot axis (the instantaneous axis of rotation). This axis is represented by a point in the planar representation. The axis may be made essentially parallel to the plane of the ground and to the longitudinal axis of the vehicle to enable the camber variations envisaged (as is apparent in the description of FIGS. 3 and 6). However, by varying the orientation of the axis additional steering, toe-in, toe-out or other effects can be produced as a function of the transverse (bend) and longitudinal (braking, acceleration) forces undergone by the wheel in the contact patch. A person with knowledge of the field will know how to carry out tests or to apply theoretical methods in order to determine the appropriate orientation to be adopted as a function of the behaviour he expects from the system. For example, tests have shown that a 6° inclination of this camber pivot axis relative to the horizontal makes it possible to induce steering related to the camber at an angle 10 times smaller than the camber angle. Thus, when the transverse forces induce a camber of 5°, the induced steering angle is about 0.5°. The inclination of the pivot axis can be obtained, for example, by fitting the vehicle with a system whose operating plane is inclined at 6° relative to the vertical. Beyond this particular example, the choice of an angle of inclination of this pivot axis enables, in a more general way, a fine tuning of the equilibrium compromise (for example in order to account for transverse forces as explained above).

The support or suspension system according to the invention can be used to compensate the deformations of the elements of the suspension system of existing vehicles and enable better performances. That is to say, the support or suspension system of the invention can be used to ensure that in all circumstances the wheel plane will remain essentially perpendicular to the ground plane or slightly inclined so as also to take account of the deformation of the tire. This objective is achieved by a system according to the invention whose useful camber amplitude is only a few degrees (for example, 8° on either side of the mean position). However, the support or suspension system of the invention can also be used to enable a much larger camber variation, i.e. to allow the suspension system to operate more like that of a motorcycle than that of vehicles with three or more wheels currently on the market.

In a general way the figures represent a wheel 2 comprising a pneumatic tire casing but the invention can of course be applied with any type of wheel with or without an elastic casing, whether pneumatic or not, an essential characteristic of the suspension system of the invention being the position of the second instantaneous center of rotation relative to the contact patch, whatever it may be.

We claim:

1. Support system designed to connect a wheel (2) to suspension elements comprising an intermediate support (4), wherein said support system comprises a wheel support (3) designed to carry said wheel (2), and at least one curved slider (10) that connects said wheel support (3) to said intermediate support (4), and wherein said at least one curved slider (10) confers upon said wheel (2) a degree of camber freedom relative to said suspension elements.

2. Support system according to claim 1, in which said at least one curved slider is a circular slider (10) comprising at least one bearing, wherein said bearing is selected from the group consisting of a ball bearing, a disc bearing, and a roller bearing.

3. Support system according to claim 1 or 2, in which said wheel (2) of radius “r” is intended to rest on the ground (S) via a contact patch (AC), and said wheel support (3), curved slider (10), and intermediate support (4) are configured such that said wheel (2) has, around a mean position, a first instantaneous center of rotation (CIR R/S) located in an interval between 2.5r above the ground and r below the ground.

4. The support system according to claim 3 wherein said instantaneous center of rotation (CIR R/S) is located in an interval between 0.5r above the ground and r below the ground.

5. Support system according to claim 3, in which said wheel support (3), curved slider (10), and intermediate support (4) are configured such that when the wheel is in a mean position the said first instantaneous center of rotation (CIR R/S) is located below the plane of the ground (S).

6. Support system according to claim 4, in which said wheel support (3), curved slider (10), and intermediate support (10) are configured such that said first instantaneous center of rotation (CIR R/S) is located transversely under said contact patch (AC).

7. Support system according to claim 3 in which the said first instantaneous center of rotation (CIR R/S) is located essentially in a wheel plane (PR).

8. Support system according to claim 3, in which said intermediate support consists of a strut (41) of a MacPherson suspension system.

9. Support system according to claim 3, further comprising control means for influencing the camber of the wheel.

10. Support system according to claim 3, in which the control means comprises an elastically deformable element which opposes the camber movement.

11. The support system of claim 3 wherein said suspension elements further comprise an upper arm (8) and a lower arm (9).

12. Suspension system (1) for a vehicle comprising a support system according to any of the preceding claims.

13. Suspension system (1) designed to connect a wheel support (3) to a vehicle body (5), the said wheel support being designed to carry a wheel of radius “r”, said wheel being intended to rest on the ground (S) via a contact patch (AC), in which the said suspension system comprises means (4, 8, 9, 10) that confer upon the wheel support, relative to the body, a degree of freedom of the camber and a degree of freedom of the suspension deflection which are independent of one another, the said system being configured such that the camber movement of the wheel support about a mean position relative to the body has a second instantaneous center of rotation (CIR R/C) located within a range between 0.5r above ground level and r below ground level.

14. Suspension system (1) according to claim 13, in which the said second instantaneous center of rotation (CIR R/C) is located within a range between 0.2r above ground level and 0.4r below ground level.

15. Suspension system (1) according to claims 13 or 14, in which the second instantaneous center of rotation (CIR R/C) of the camber movement of the wheel support (3) relative to the body (5) is located below the plane of the ground (S) such that transverse forces (Fy) exerted by the ground on the wheel (2) in the contact patch (AC) induce an inclination of the wheel support (3) relative to the body in the direction of decreasing camber when the said transverse forces are directed towards the inside of the vehicle and in the direction of increasing camber when the said transverse forces are directed towards the outside of the vehicle.

16. Suspension system (1) according to any of claim 13, wherein the said degree of camber freedom is controlled by a control means for influencing the camber of the wheel.

17. Vehicle equipped with a suspension system (1) according to any of claims 12 to 16.
